(19) United States
(12) Patent Application Publication
(10) Pub. No.: US 2025/0390569 A1
(43) Pub. Date: Dec. 25, 2025

(54) METHODS AND APPARATUS FOR DATA PROCESSING IN A TRUSTED EXECUTION ENVIRONMENT

(71) Applicant: Canary Bit AB, Stockholm (SE)

(72) Inventors: Nicolae PALADI, Stockholm (SE); Stefano CUCCHIELLA, Stockholm (SE)

(21) Appl. No.: 18/877,623

(22) PCT Filed: Jun. 22, 2023
(86) PCT No.: PCT/SE2023/050655

§ 371 Date: Dec. 20, 2024

(30) Foreign Application Priority Data
Jun. 23, 2022 (SE) 2250789-1

(51) Int. Cl. G06F 21/53

(52) U.S. Cl. CPC G06F 21/53; G06F 2221/034

(57) ABSTRACT

A computer-implemented method comprising: receiving, at a data processing pipeline comprising a trusted execution environment: a data-processing function from a data-processing function owner; a raw-data set from the data owner; generating, in the data processing pipeline, analysis results, based on the raw-data set, by using the data-processing function; providing the analysis results to an output; and erasing the data-processing function, the raw-data set, and the analysis results, from the data processing pipeline. Wherein: the raw-data set is provided by the data owner in response to satisfaction of first-user trustworthiness-criteria determined by the trusted execution environment using a first-user remote-attestation-procedure; and the data-processing function is provided by the data-processing function owner in response to satisfaction of second-user trustworthiness-criteria determined by the trusted execution environment using a second-user remote-attestation-procedure.

The present disclosure relates to a system for data processing in a trusted execution environment and in particular, although not necessarily, such that two or more distinct users may collaborate confidentially.

### SUMMARY

According to a first aspect of the present disclosure there is provided a computer-implemented method, the method comprising:
receiving, at a data processing pipeline comprising a trusted execution environment (TEE):
   a data-processing function from a data-processing function owner;
   a raw-data set from a data owner;
generating, in the data processing pipeline, analysis results, based on the raw-data set, by using the data-processing function;
providing the analysis results to an output; and
erasing the trusted execution environment to erase the data-processing function, the raw-data set, and the analysis results;
wherein:
   the raw-data set is provided by the data owner in response to satisfaction of first-user trustworthiness-criteria verified by the data owner using a first-user remote-attestation-procedure; and
   the data-processing function is provided by the data-processing function owner in response to satisfaction of second-user trustworthiness-criteria verified by the data-processing function owner using a second-user remote attestation procedure.

Optionally, the output may provide the analysis result to the data owner.

The verification of the first-user or second-user trustworthiness-criteria by the corresponding owner, may be direct verification by the corresponding owner or verification on behalf of the corresponding owner by a third-party.

Preferably, the method further comprises establishing the trusted execution environment in a volatile memory device, such as in a random access memory (RAM) device, or other types of volatile memory such as a cache memory or a register memory.

Typically, the method further comprises establishing the trusted execution environment according to criteria defined by at least one of the data owner and the data-processing function owner.

Typically, the criteria for assessing the trustworthiness of a trusted execution environment are selected and defined by at least one of the data owner and the data-processing function owner, and may be based on factors such as the relevant owner's organizational policies, threat model, compliance requirements, legal requirements or technical constraints. Examples of possible criteria include cryptograph cyphers used by the trusted execution environment, cryptographic key lengths, make and model of the hardware platform where the trusted execution environment is running, version of the platform firmware, or version of the embedded code running in the trusted execution environment.

Preferably, in the cases of both the data owner and the data-processing function owner, the relevant owner obtains via the remote attestation procedure a message containing the information on the trusted execution environment. This message is signed by a key on the hardware platform, so the owner can verify it is genuine. The owner then reviews this information to (i) validate it was not malformed or fake and (ii) assess whether the values communicated by the TEE are acceptable to verify that it meets the trustworthiness-criteria. For example, there might be TEEs which are set up with an older platform firmware version, and while that might be acceptable for some workloads, it is not sufficient for some other ones with stricter security requirements. It is the owner (or a third party acting on behalf of the owner) that verifies that the trustworthiness-criteria are met and takes the decision to trust or not to trust the TEE for the task at hand.

Preferably erasure of the trusted execution environment results in permanent erasure of the data-processing function, the raw-data set and the analysis results from the data-processing pipeline.

Preferably, the data processing pipeline comprises a number of trusted execution environments, each trusted execution environment may include a unique trusted execution environment identity. The trusted execution environment identity may include, for example, a cryptographic private key, an X.509 certificate containing the cryptographic private key or a token, such as the Json Web Token (JWT). Typically, each trusted execution environment is erased after the analysis results associated with that trusted execution environment are provided to the output.

Preferably, at least one of the raw-data set and the data-processing function are provided via a secure data link.

Optionally, the method may comprise:
receiving, at the data processing pipeline a training-data set from the data owner, the training-data set suitable for training the data-processing function; and
wherein the training-data set is provided by the data owner in response to satisfaction of the first-user trustworthiness-criteria determined by the trusted execution environment using the first-user remote-attestation-procedure; and erasure of the trusted execution environment also erases the training-data set.

Optionally, the training-data set may comprise a synthetic-data sample generated by the data owner, wherein the synthetic-data sample may be:
statistically representative of the raw-data set; and
distinct from the raw-data set.

Optionally, the synthetic-data sample excludes any confidential data.

Optionally, the method may comprise:
receiving a synthetic-data generator at the data processing pipeline;
processing, in a first-trusted-execution environment of the trusted execution environment, the training-data set, using the synthetic-data generator, to generate a synthetic-data sample, wherein:
   the training-data set may comprise a raw-data sample, wherein the raw-data sample may be statistically representative of the raw-data set; and
   the synthetic-data sample may be:
      statistically representative of the raw-data set;
      distinct from the raw-data sample and the raw-data set; and
      suitable for training the data-processing function;
wherein the training-data set may be provided by the data owner in response to satisfaction of a first-user first-trust-criterion of the first-user trustworthiness-criteria determined by the first-trusted-execution environment using a first-user first-remote-attestation-protocol of the first-user remote-attestation-procedure.

Optionally, the synthetic-data sample may be generated in the first-trusted-execution environment, using the synthetic-data generator, from a plurality of training-data sets, including the training-data set, each respective training-data set may be provided by a respective data owner in response to satisfaction of a respective user-first-trust-criterion of respective user-trustworthiness-criteria, each respective satisfaction determined by the first-trusted-execution environment using a respective user-first-remote-attestation-protocol of a respective user-remote-attestation-procedure.

Optionally, the data-processing function may be an untrained-data-processing function provided by the data-processing-function owner in response to satisfaction of a second-user first-trust-criterion of the second-user trustworthiness-criteria, determined by the first-trusted-execution environment using a second-user first-remote-attestation-protocol of the second-user remote-attestation-procedure.

Optionally, the method may comprise:
using the first-trusted-execution environment to determine:
   a trained-data-processing function based on the untrained-data-processing function and the synthetic-data sample; and
   the analysis results, based on the raw-data set, by using the trained-data-processing function, wherein the raw-data set may be provided by the data owner in response to satisfaction of a second first-user first-trust-criterion of the first-user trustworthiness-criteria determined by the first-trusted-execution environment using a second first-user first-remote-attestation-protocol of the first-user remote-attestation-procedure; and
erasing the first-trusted-execution environment to erase the trained-data-processing function and the synthetic-data sample from the data processing pipeline.

Optionally, the method may comprise:
providing the synthetic-data sample to the data-processing-function owner; and
erasing the synthetic-data sample from the data processing pipeline.

Optionally, the method may comprise:
in response to satisfaction of a second-user second-trust-criterion of the second-user trustworthiness-criteria, determined by a second-trusted-execution environment, of the trusted execution environment, using a second-user second-remote-attestation-protocol of the second-user remote-attestation-procedure, receiving at the data processing pipeline the data-processing function;
wherein the data-processing function may be a trained-data-processing function, trained using the synthetic-data-sample by the data-processing-function owner.

Optionally, the method may comprise:
using the second-trusted-execution environment to determine the analysis results, based on the raw-data set, by using the trained-data-processing function;
wherein the raw-data set may be provided by the data owner in response to satisfaction of a first-user second-trust-criterion of the first-user trustworthiness-criteria determined by the second-trusted-execution environment using a first-user second-remote-attestation-protocol of the first-user remote-attestation-procedure.

Optionally, the method may comprise:
receiving the synthetic-data sample at a second-trusted-execution environment of the trusted execution environment;
in response to satisfaction of a second-user second-trust-criterion of the second-user trustworthiness-criteria, determined by the second-trusted-execution environment, using a second-user second-remote-attestation-protocol of the second-user remote-attestation-procedure, receiving at the data processing pipeline the data-processing function, wherein the data-processing function may be an untrained-data-processing function;
determining a trained-data-processing function, using the second-trusted-execution environment, based on the synthetic-data sample and the untrained-data-processing function;
providing the trained-data-processing function to the data-processing-function owner; and
erasing the trained-data-processing function and the synthetic-data sample from the data processing pipeline.

Optionally, the method may comprise:
in response to satisfaction of a second-user third-trust-criterion of the second-user trustworthiness-criteria, determined by a third-trusted-execution environment, of the trusted execution environment, using a second-user third-remote-attestation-protocol of the second-user remote-attestation-procedure, receiving at the third-trusted-execution environment the trained-data-processing function from the data-processing-function owner.

Optionally, the method may comprise:
in response to satisfaction of a first-user third-trust-criterion of the first-user trustworthiness-criteria, determined by the third-trusted-execution environment using a first-user third-remote-attestation protocol of the first-user remote-attestation-procedure, receiving at the third-trusted-execution environment the raw-data set;
determining, by the third-trusted-execution environment, the analysis results from the raw-data set and the trained-data-processing function; and
erasing the trained-data-processing function from the data processing pipeline.

Optionally, a comparison of the synthetic-data sample with the raw-data set may satisfy a statistical similarity threshold.

According to a further aspect of the present disclosure there is provided a system comprising:
at least one processor; and
at least one memory including computer program code for one or more programs, the at least one memory and the computer program code configured to, with the at least one processor, perform any method disclosed herein.

Preferably, the at least one memory comprises a volatile memory device, such as a random-access memory (RAM) device or CPU cache. Typically, the trusted execution environment is established within the volatile memory device, and preferably, exclusively within the volatile memory.

The volatile memory device may be any suitable volatile memory device, such as static random-access memory (SRAM), dynamic random-access memory (DRAM), embedded SRAM (eSRAM), embedded DRAM (eDRAM), cache memory, or register memory.

An advantage of establishing the trusted execution environment exclusively within the volatile memory device is that erasure of the trusted execution environment is a simpler and more reliable process. Furthermore, itenables more secure erasure of the processed payload (code and data) than if the trusted execution environment is established within a read-only memory (ROM) device or a combination of volatile and non-volatile memory devices.

A further advantage is that extraction of encrypted information during computation is more difficult from volatile storage and significantly more difficult or impossible (considering current state of the art) after the erasure (or termination) of the TEE.

Preferably, the at least one memory is encrypted memory.

According to a further aspect of the present disclosure there is provided a computer program product comprising instructions which, when executed on a processor, cause the processor to perform any method disclosed herein.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example of a cloud computing system according to prior art with independently certified security guarantees;

FIG. 2 shows an example of a cloud computing system according to prior art that enables cooperation between two separate users;

FIG. 3 shows an example of a cloud computing system according to prior art that enables encrypted cooperation between two separate users;

FIG. 4 shows an example embodiment of a cloud computing system that uses remote attestation to provide secure cooperation between two users of a trusted execution environment;

FIG. 5 shows an example embodiment of a flow diagram of the steps by which two users can securely cooperate using a single trusted execution environment;

FIG. 6 shows an example embodiment of a flow diagram of the steps by which two users can securely cooperate using two distinct trusted execution environments;

FIG. 7 shows an example embodiment of an overview flow diagram of the steps by which two users can securely cooperate using three distinct trusted execution environments;

FIG. 8 shows an example embodiment of a detailed flow diagram of the steps by which two users can securely cooperate using three distinct trusted execution environments;

FIG. 9 shows an example embodiment of a cloud computing system for generating a trained model; and

FIG. 10 shows an example embodiment of a cloud computing system for analysing raw data using a trained model.

### DETAILED DESCRIPTION

Cloud computing providers offer cost-effective services for data storage, processing capacity and virtual network infrastructure, with acceptable security guarantees of data confidentiality, integrity, and availability.

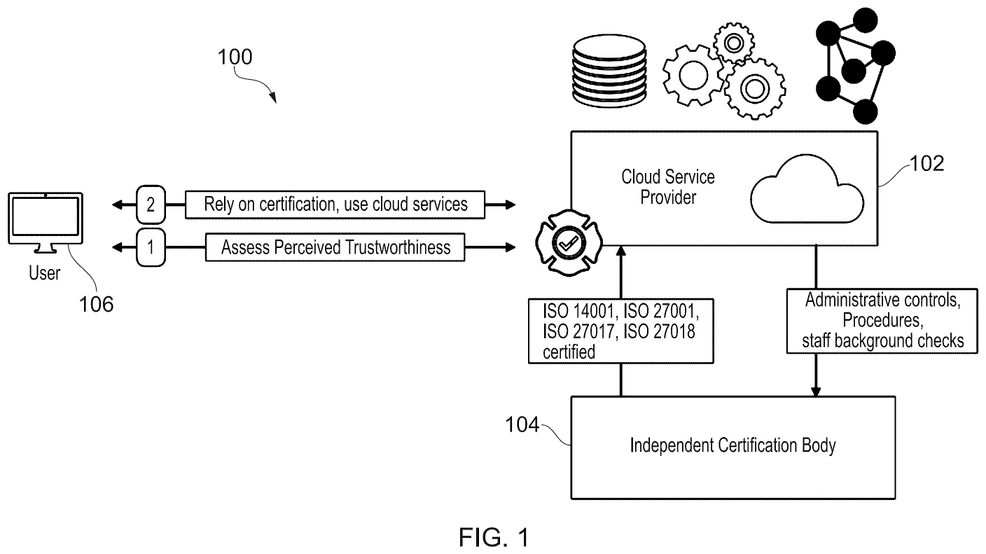

FIG. 1 shows a cloud computing system 100. A cloud service provider 102 cooperates with an independent certification body 104 to generate security guarantees. To provide such security guarantees, the cloud service provider 102 enforces extensive and thorough security protocols that consist of a mix of administrative and technical processes. Examples of such administrative processes include strong physical security of data centres, combined with security vetting of staff with privileged access to customer data and systems and with the separation of system administration privileges, etc. The cloud service provider may thus obtain various certifications confirming the presence of administrative controls to ensure security of data and software from the independent certification body 104. However, such certifications can only enhance the perceived trustworthiness of the cloud service provider 102. These systems do not provide any technically verifiable security guarantees to an end customer or user 106 who rely on the perceived trustworthiness of the cloud service provider 102.

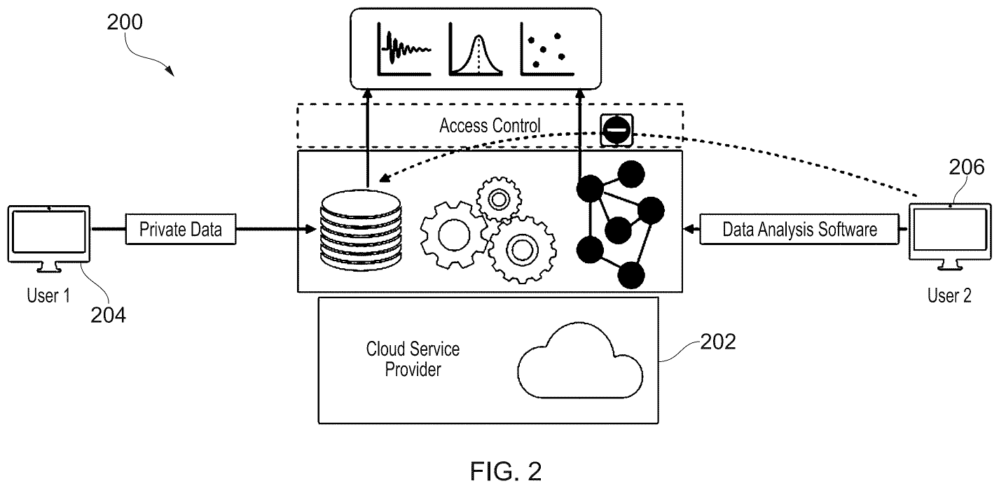

Recognizing the need for data collaboration across organizational borders, some cloud providers have started offering tools for secure data collaboration. FIG. 2 shows an example cloud computing system 200 with a cloud service provider 202. In this simple two-partner scenario, user one 204 provides data, and user two 206 provides the software algorithm implementations to analyse the data (henceforth called a data processing function, or DPF). Such services often rely on additional access control protocols atop regular cloud services and currently do not widely employ hardware-enforced security mechanisms. Thus, the security and trustworthiness of cloud secure data collaboration services rely entirely on the declared trustworthiness of the cloud service provider 202. Moreover, end users 204, 206 of such services must trust the cloud service provider 202 and correctness of the access control protocols they implement. Here too, the end users 204, 206 of secure data collaboration services cannot obtain technically verifiable security guarantees about the service.

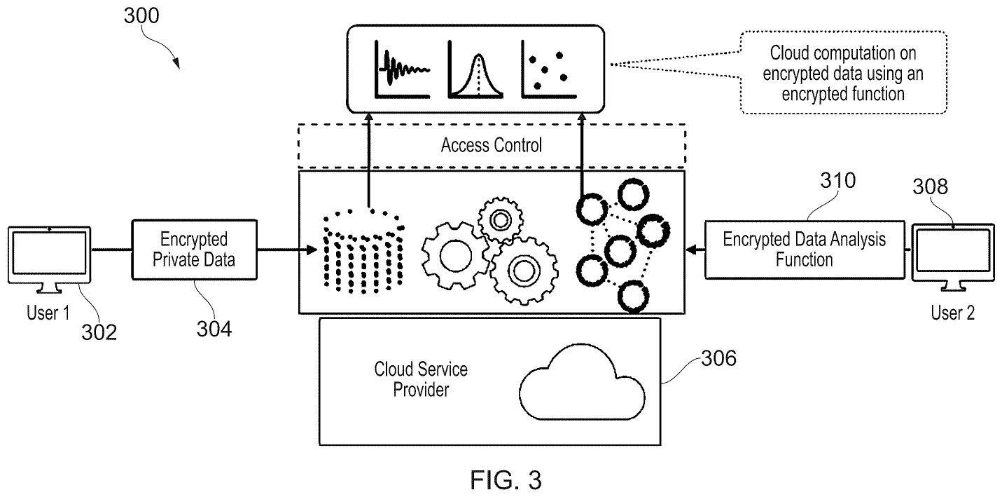

FIG. 3 shows an example cloud computing system 300 in which secure data collaboration is achieved using privacy enhancing technologies based on cryptographic solutions for multi-party computation. In this simple example, an individual data controller or user one 302 encrypt their data using for example a special-purpose cryptographic function (F1) and provides the encrypted private data 304 to a cloud service provider 306. A separate data processing function controller or user two 308 provides an encrypted data analysis function (F2) 310 to the cloud service provider 306 to perform computations on the data 304 encrypted using F1. While this enables collaboration and protects data privacy, this approach currently only allows rudimentary computations at a very high computational cost.

Fully Homomorphic Encryption (FHE) is a promising approach that allows the performance of arbitrary computations on encrypted data. This requires encrypting data with specific encryption schemes, currently only supports rudimentary operations and data of small size and has currently a very high computational cost. However, research is rapidly advancing in this field and may yield better results in the future.

In some scenarios involving machine learning, techniques such as federated learning can be employed to enable collaboration between two or more parties. In this case, one party (the Model Owner) develops the machine learning (ML) model and dispatches it to one or more individual data controllers that locally train the model on their data; after that the trained local models are aggregated by the model developer. However, this scenario focuses only on protecting the confidentiality of data and not of the ML model, since individual data controllers could access and reverse-engineer the ML model they receive. Moreover, research has shown that ML models can leak confidential data that was used to train them.

Existing solutions to the problem of how to enable separate parties, a data owner and a date processing function owner, to co-operate while maintaining the confidentiality of their respective information have the following difficulties and limitations.
Prior art solutions enabling collaboration between a data owner (or controller) and the owner of a data processing function (DPF) rely on a human factor for their security, where an administrator manages access and can view the digital assets, such as data, code implementing the data processing function, and configuration parameters etc.
Prior art solutions are based on legal agreements that primarily and merely define the responsibility of the principals in the eventuality of data leaks and are not capable, technically, to prevent such leaks.
Emerging prior art solutions for collaboration between a data controller and a DPF owner where the confidentiality of digital assets is guaranteed are computationally expensive, can only perform rudimentary operations and have poor scalability.
In prior art solutions, digital assets of cloud users can be accessed in plain text by cloud service provider staff as part of maintenance activities. Thus, the members of the staff that handle the cloud customer environment must be specifically trained and must often meet compliance requirements in terms of nationality, criminal record, etc.

A solution to the above difficulties and limitations is especially needed to:
enable practical secure collaboration for advanced data analysis between competing or mutually distrusting organizations, individuals, or combinations thereof;
enable individuals and organizations to provide third party access to their data for specific computations, without disclosing the data in plain text;
enable data analysts to access data from many potentially competing data controllers to train or test their data processing functions, for example ML models;
enable new data business models, where data controllers sustainably monetize data by repeatedly providing access to data without ever disclosing data in plaintext to third parties;
eliminate the possibility that cloud service provider staff can view or otherwise access customer digital assets in plain text while conducting maintenance operations;
enable strong technical protection of digital assets (such as data, code, configuration parameters etc.) and reduce the complexity of legal negotiations in case of data collaboration between two or more organizations.

The shortcomings listed above can be addressed through a system that chains a set of computation states in trusted execution environments (TEEs) whose integrity and confidentiality is assessed through an attestation protocol.

The computation states can be selectively trusted by the participants in the confidential data collaboration protocol. The said computational states are established in TEEs, which can be implemented using technologies such as Intel SGX, AMD SEV-SNP, IBM PEF, Intel TDX, ARM CCA or other similar environments that provide confidentiality and integrity guarantees verifiable through attestation and based on a hardware or a firmware root of trust. The combination of confidential computation states, their inputs (data and algorithm implementations, ML models etc.), and their outputs (synthetic data sets, data features, refined algorithms implementations, fine-tuned data processing functions such as trained ML models) enable two or more potentially competing parties to establish a trustworthy collaboration while maintaining verifiable control over their digital assets.

In summary, the solution comprises generating synthetic data in a TEE (based on actual data), fine-tuning the DPF (for example training an ML model) using synthetic data in a TEE, and finally using a TEE to analyse data using the fine-tuned DPF (for example a trained ML model). At various steps the security properties of the TEE can be evaluated by the owner of the digital asset using an attestation protocol. As a result, the owners of digital assets (data, code, configurations) do not need to trust each other; instead, they establish a trustworthy collaboration relationship by relying on a common root of trust, namely the cryptographic signing key of the vendor of the hardware platform where the computation is done. This can be compared to Internet users and web services that rely on a common root of trust (such as the Certificate Authority in a Public Key Infrastructure) to establish a secure communication channel.

Methods for collaborative confidential data analysis are described below. The nature of the data analysis is not relevant for the implementation of the method and may include various approaches of statistical analysis, machine learning, business intelligence etc. These methods may be deployed using existing or announced or future implementations of Trusted Execution Environments with remote attestation capabilities, such as AMD SEV-SNP, Intel SGX, Intel TDX, IBM PEF, ARM CCA, and others. The methods enable collaborative confidential data analysis through a series of steps described below. This collaboration involves several distinct participant roles.
Data Processing Function (DPF) Owner—a participant that builds and operates tools for data analysis, such as machine learning models, proprietary algorithms for data analysis, etc.
Data owner (or data controller)—a participant that controls data that can be analyzed using tools and methods provided by the DPF owner.
Optionally, there may be a further participant, the Synthetic data generator (which in some instances could instead be the data owner, or be included or comprised in the data owner)—a participant that provides tools for synthetic data generation. The tools take as input a sample (or all) of raw data and generate a dataset that has identical or similar statistical properties but does not contain any private information. The private information may be confidential company related information of confidential personal information or any other information that should be kept secret. The tools for synthetic data generation may be proprietary or open source.

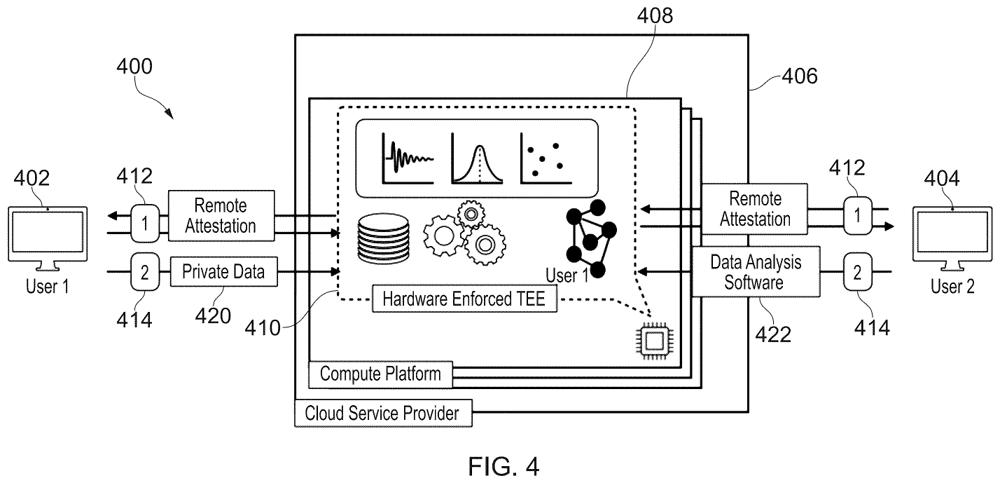

FIG. 4 illustrates a high-level overview 400 of a system architecture and components required to implement a secure collaboration between two users. The two collaborating users, a first user 402 and a second user 404, interact with a cloud service provider 406 (or simply a cloud service) that operates on hardware or virtualized computer platforms 408 with support for a Trusted Execution Environment (TEE) 410. The first user 402 is an example of a data owner, while the second user 404 is an example of a data-processing function owner. In a first step 412 the users 402, 404 assess the trustworthiness of the TEE instance 410 based on attestation results obtained through remote attestation.

The first step 412 can be divided into a first user remote attestation procedure undertaken by the first user 402 and a second user remote attestation procedure undertaken by the second user 404. Successful completion of the first user remote attestation procedure can be described as satisfaction of a first user trustworthiness criteria of the first user remote attestation procedure, while successful completion of the second user remote attestation procedure can be described as satisfaction of a second user trustworthiness criteria of the second user remote attestation procedure. If a third, or subsequent, user is involved in the process then a third, or subsequent, user trustworthiness criteria of a third, or subsequent, user remote attestation procedure may be satisfied to establish the trustworthiness of the TEE 408 to the satisfaction of the third, or subsequent, user.

In this example, there is a single TEE 410 and therefore the first user and second user remote attestation procedures are only required to establish the trustworthiness of the single TEE 410 for the first user 402 and the second user 404, respectively. However, in other examples discussed below, a plurality of trusted execution environments may be used. In such cases, the first user remote attestation procedure may comprise a plurality of first user remote attestation protocols, one or more for each respective TEE, which may provide for the trustworthiness of each respective TEE by satisfaction of a respective first user trust criterion of the first user trustworthiness criteria. Similarly, for a second, or subsequent, user, satisfaction of a second (or subsequent) user trust criterion of the second (or subsequent) user trustworthiness criteria, may be required for each respective second (or subsequent) user remote attestation protocol of the second (or subsequent) user remote attestation procedure for each respective TEE.

In the following, where a plurality of distinct hardware enforced Trusted Execution Environments are used, it is possible to refer to a first TEE, a second TEE, etc., as making up ‘the’ Trusted Execution Environment, where the distinct subcomponent TEE's are distinguished by the appropriate designation as ‘first’, ‘second’, etc. In such cases, it will be appreciated that the first TEE may be entirely remote from the second TEE and any other TEE's as is conventional for distinct hardware components that co-operate in cloud computing systems. Collectively, a data processing pipeline may be said to comprise such a plurality of trusted execution environments. In such cases, a remote attestation protocol relevant to the first TEE may be called a first-remote attestation protocol, while a second-remote-attestation protocol may be relevant to the second TEE, and so on.

Once the trustworthiness of the TEE 410 is established, in a second step 414 the first user 402 deploys its raw data set 420 to the TEE 410 while the second user 404 deploys a data processing function 422 in the form of any one or more of data analysis software, algorithms and models to the TEE 410.

The user deploys data through a secure communication channel, established using an exchange of cryptographic keys, optionally encoded in commonly adopted standard certificate formats, such as X.509 (and subsequent versions) or a cryptographic token, such as in the JSON Web Tooken (JWT) format. The cryptographic material in the certificate or token is bound to the attestation results produced by the TEE, for example by including the attestation results as an extension of or as part of the certificate. As a result, the identity of the TEE is reliably bound to the attestation results it produces through an attestation procedure.

Optionally, the data owner may validate the attestation results against a third-party validation service that verifies the (a) security claims of the TEE, (b) the validity of the cryptographic signatures endorsing the attestation results (for example cryptographic signatures using keys operated by the platform owner or platform vendor).

Optionally, the X.509 certificate generated in the TEE and containing the attestation report produced by the TEE may be cryptographically signed by a third party (such as a certificate authority), trusted by the data owner (or owner of the data processing function).

Optionally, the decision to endorse the trustworthiness of the TEE by signing its X.509 certificate containing the attestation report is based on the values contained in the validation report and results of its validity assessment.

The software/algorithm/model 422 can be applied to the raw data set 420 to generate analysis results (not shown) that can be securely provide to the first user 402 (i.e., provided to the data owner). The TEE 410 enables the performance of the following task: first user 402 needs to analyze a raw data set using tools, models or algorithms provided by the second user 404 (the DPF owner) without disclosing the entire raw data to the DPF owner. Similarly, the second user 404 does not want to disclose its model, tools, or algorithms to the first user 402.

The Trusted Execution Environment 410 comprises hardware where digital assets (in the form of data, code, machine learning models, or other intellectual property in digital form) can be provisioned. Once a digital asset is deployed to the Trusted Execution Environment 410 through a secure channel, it comprises a confidential computation state (CCS). A CCS has verifiable trustworthiness properties, such as for example the hardware platform vendor, the type of TEE (and its inherent security properties), the length and type of cryptographic keys used to protect the digital asset in the TEE 410 or the cryptographic cipher used to encrypt the digital asset using the said cryptographic keys. The list of trustworthiness properties can include additional attributes not mentioned above.

In one example of the invention, the state of the TEE and its payload (including code, data, and configuration) is maintained exclusively in volatile memory such as RAM and CPU caches, explicitly excluding access to non-volatile storage (such as hard drive, magnetic storage and ROM) to reduce the risk of data recovery through advanced cryptologic attacks.

Optionally, the TEE may use additional security techniques such as oblivious RAM (ORAM) to reduce or eliminate the risk of certain attacks including side-channel attacks, or privacy-protection techniques for data stored in CPU caches.

Typically, the volatile memory is an encrypted memory device.

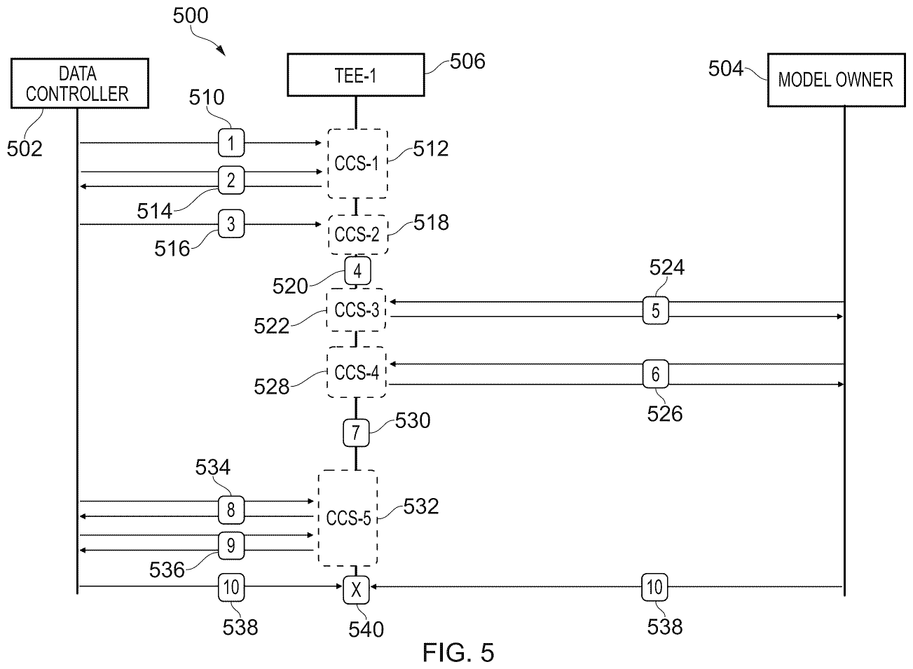

FIG. 5 shows a flow diagram 500 illustrating the steps by which a data controller 502 (which is an example of a data owner) can collaborate confidentially with a model owner 504 (which is an example of a data processing function owner) using a single Trusted Execution Environment (TEE-1) 506.

In a first step 510, the data controller 502 initiates a first confidential computation state (CCS-1) 512 by deploying a synthetic data generation tool (which is an example of a synthetic-data generator) to the Trusted Execution Environment TEE-1 506. In a second step 514, the data controller 502 uses a first first-user first-remote-attestation protocol supported by TEE-1 506 to obtain the trustworthiness properties of the created confidential computation state CCS-1 512. In this instance, since there is only a single Trusted Execution Environment (TEE-1 506) there needs to be more than one first-user first-remote-attestation protocol, hence the reference to the ‘first’ first-user attestation protocol present in the first step 510, while further trustworthiness properties of a subsequent confidential computation state (discussed below) are obtained using a ‘second’ first-user first-remote-attestation protocol.

In a third step 516, since according to the data controller policy the obtained trustworthiness properties are sufficient to trust the security of CCS-1 512 (that is, since a first-user first-trust criterion of first-user trustworthiness criteria is satisfied, as determined by the attestation information obtained from TEE-1 506 using a first-user first-remote-attestation protocol of a first user remote attestation procedure), then the data controller 502 provisions a statistically representative data sample to the TEE-1 506, thereby creating a new confidential computation state (CCS-2) 518. The statistically representative data sample is an example of a synthetic-data sample. The statistically representative data sample is an example of a training-data set, which is suitable for training a data-processing function, such as a model owned by the model owner 504. To be statistically representative of a confidential raw data set, the synthetic-data sample may satisfy a statistical similarity threshold, such as may be defined by any suitable statistical method, for example by the use of correlation functions.

The statistically representative data sample or set is produced from raw data such that private information in the raw data is excluded while statistical properties of the raw data are maintained in the statistically representative data sample. The private information may be time data, company confidential data or information about persons, the privacy of which should be protected.

In a fourth step 520 (once the synthetic data generation tool has processed the sample data in CCS-2 518) the TEE-1 506 produces a synthetic data set (or equivalently a synthetic data sample) with statistical properties identical (or similar) to those of the provided data sample, but without containing any private/confidential information, which is CCS-3 522. The degree of similarity of the statistical properties depends on the implementation of the synthetic data generation tool, which may take any statistically appropriate form.

In a fifth step 524, the model owner 504 uses a second-user first-remote-attestation protocol supported by TEE-1 506 to obtain the trustworthiness properties of the confidential computation state CCS-3 522.

In a sixth step 526, if according to the model owner 504 policy the obtained trustworthiness properties are sufficient to trust the security of CCS-3 522, then the model owner 504 provisions its tools for data analysis (machine learning models, proprietary algorithms for data analysis, or other models etc.) to TEE-1 506, creating a new confidential computation state, CCS-4 528.

In a seventh step 530, the synthetic data generation tools process the synthetic data set and output a trained-data-processing function. The trained-data-processing function is an example of adjusted data analysis tools. In some examples the trained-data-processing function may be produced in a co-operative process in which the model owner 504 adjusts the said tools for optimal performance given the specific type of synthetic data sample and its statistical properties. Examples of such adjustment are machine learning model training and re-training, parameter tuning, algorithm adjustment, model fitting, etc. The adjusted data analysis tools deployed in TEE-1 506 enable the formation of a new confidential computation state CCS-5 532.

In an eighth step 534, the Data Controller 502 uses a second first-user first-remote-attestation protocol supported by TEE-1 506 to obtain the trustworthiness properties of the confidential computation state CCS-5 532.

In a ninth step 536, if according to the relevant Data Controller policy the obtained trustworthiness properties are sufficient to trust the security of the CCS-5 532, the Data Controller 502 provisions a raw data set to TEE-1 506, where the raw data set is analyzed using the trained tools provisioned by the model owner 504 in the seventh step 530. The analysis results are then provided as an output either to the Data Controller 502 or to any other appropriate receiver of the analysis results.

In a tenth step 538, once the analysis results have been obtained by the Data Controller 502, either the Data Controller 502 or the model owner 504 (or both together) securely erase 540 all confidential data from TEE-1 506 and tear down TEE-1 506 to prevent any potential leakage of private information about the raw data or the proprietary data analysis tools. Tear down (or erasure) of the TEE necessarily results in the entire deletion of the TEE and all the information within the TEE, including the model and all data.

To illustrate the method of FIG. 5, the following use-case is disclosed. The data controller 502 (which may be a manufacturing company, for example) has a time series data set produced by an industrial manufacturing process. A data analysis company (which is an example of the model owner 504) offers to improve the manufacturing process and reduce failure instances, based on insights that can be obtained by analyzing the time series data with a proprietary machine learning model. The data controller 502 is not willing to disclose the time series data from the industrial manufacturing process, since if the data is leaked to competitors, they may be able to recreate the proprietary manufacturing process. Conversely, the data analysis company is not willing to deploy its proprietary machine learning model to avoid disclosing it to the data controller 502 or losing control over its future use.

To solve the above problem, a third party service provider enables the method of FIG. 5 via a cloud service using TEE-1 506. The data controller 502 first creates a synthetic data set based on a representative sample of its time series data set (steps one to four above). Once the synthetic data set is created, the data controller 502 enables the data analysis company to fine-tune its machine learning algorithms using the synthetic data, using the same trusted execution environment TEE-1 506 (steps five to seven above). Finally, in the same trusted execution environment TEE-1 506, the genuine, confidential, time series data is analyzed using the fine-tuned machine learning model (steps eight and nine above). The obtained insights can be used to improve the manufacturing process, while the confidential data is erased from the TEE-1 506 in a final step (step ten above).

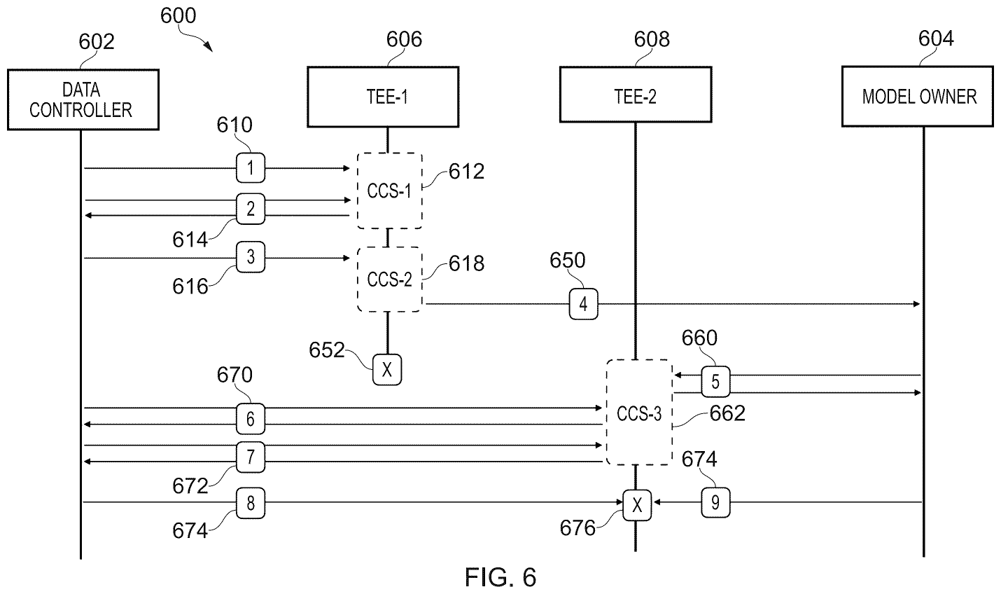

FIG. 6 shows a flow diagram 600 illustrating the steps by which a data controller 602 can collaborate confidentially with a model owner 604 using two distinct Trusted Execution Environments, a first trusted execution environment TEE-1 606 and a second trusted execution environment TEE-2 608. Similar features in FIG. 6 to those present in FIG. 5 have been given similar reference numerals and may not necessarily be discussed further here to improve the clarity and conciseness of the disclosure. In particular, the features of the first 610, second 614 and third 616 steps (which correspond to those steps disclosed above in relation to FIG. 5) will not be discussed further here.

In a fourth step 650, the TEE-1 606 produces a synthetic data sample and provides the synthetic data sample to the model owner 604. This enable the model owner 604 to create a trained-data-processing function from an untrained-data-processing function in a secure environment that they control. The synthetic data sample having been provided to the model owner 604, the TEE-1 606 is then securely erased 652.

In a fifth step 660, the model owner 604 uses a second-user second-remote-attestation protocol supported by TEE-2 608 to obtain the trustworthiness properties of a confidential computation state CCS-3 662. The trustworthiness properties are satisfactory when a second-user second-trust-criterion of the second-user trustworthiness-criteria are determined to be satisfactory by TEE-2 608. In this case the fifth step 660 also includes receiving, at TEE-2 608, the trained-data-processing function from the model owner 604

In a sixth step 670, the Data Controller 602 uses a first-user second-remote-attestation protocol supported by TEE-2 608 to obtain the trustworthiness properties of the confidential computation state CCS-3 662.

In a seventh step 672, since according to the relevant Data Controller policy the obtained trustworthiness properties are sufficient to trust the security of the CCS-3 662, the Data Controller 602 provisions a raw data set to TEE-2 608, where the raw data set is analyzed using the trained-data-processing function to generate the desired analysis results. The analysis results are then provided as an output to the Data Controller 602.

In a tenth step 674, once the analysis results have been obtained by the Data Controller 602, either the Data Controller 602 or the model owner 604 (or both together) securely erase 676 all confidential data from TEE-2 608 to prevent any potential leakage of private information about the raw data or the proprietary data analysis tools.

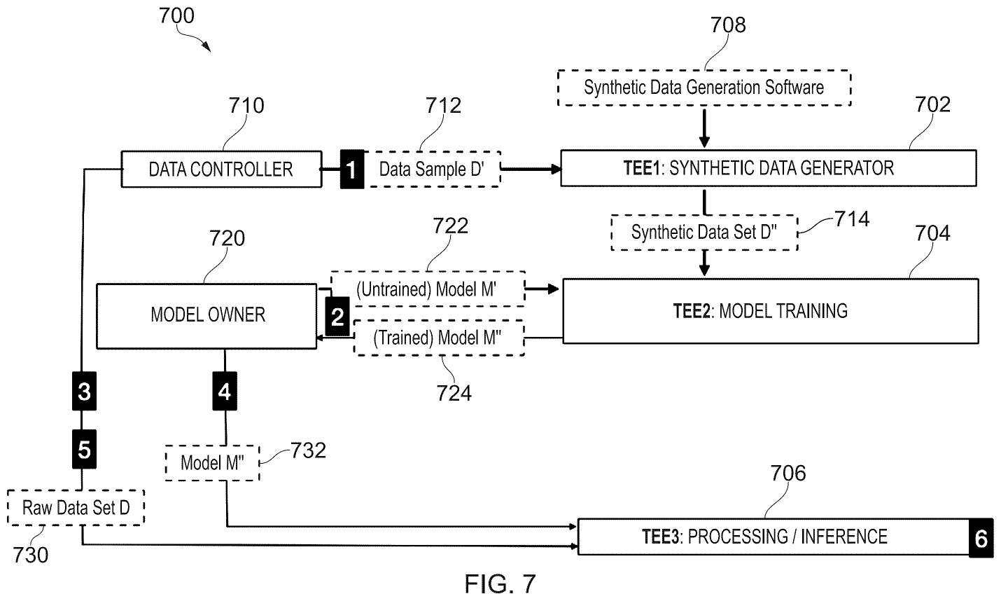

FIG. 7 shows a conceptual overview of a flow diagram 700 for a system that can implement methods of the present invention using three distinct trusted execution environments: a first trusted execution environment TEE-1 702; a second trusted execution environment TEE-2 704; and a third trusted execution environment TEE-3 706.

A Data Controller 710 deploys a data sample D′ 712 to TEE-1 702 which has synthetic data generator software 708 (which has been obtained from any suitable source). TEE-1 702 then produces a synthetic data sample D″ 714 using the data sample D′ 712 and the synthetic data generator software 708.

A model owner 720 provides an untrained model M′ 722 (which is an example of an untrained-data-processing function) to TEE-2 704, which performs fine-tuning to generate a trained model M″ 724 (which is an example of a trained-data-processing function) by making use of the synthetic data set D″ 714.

Next, the Data Controller 710 initializes TEE-3 706 for data processing, the model owner 720 deploys 732 the fine-tuned trained machine learning model M″ 724 and then the Data Controller 710 deploys a raw data set D 730 for processing. The processing performed by TEE-3 706 generates the desired analysis results (not shown) which can then be provided to the Data Controller 710.

At each step, when any of the trusted execution environments TEE-1 702, TEE-2 704, TEE-3 706 has completed its processing its memory can be securely erased to provide for the security of the relevant information.

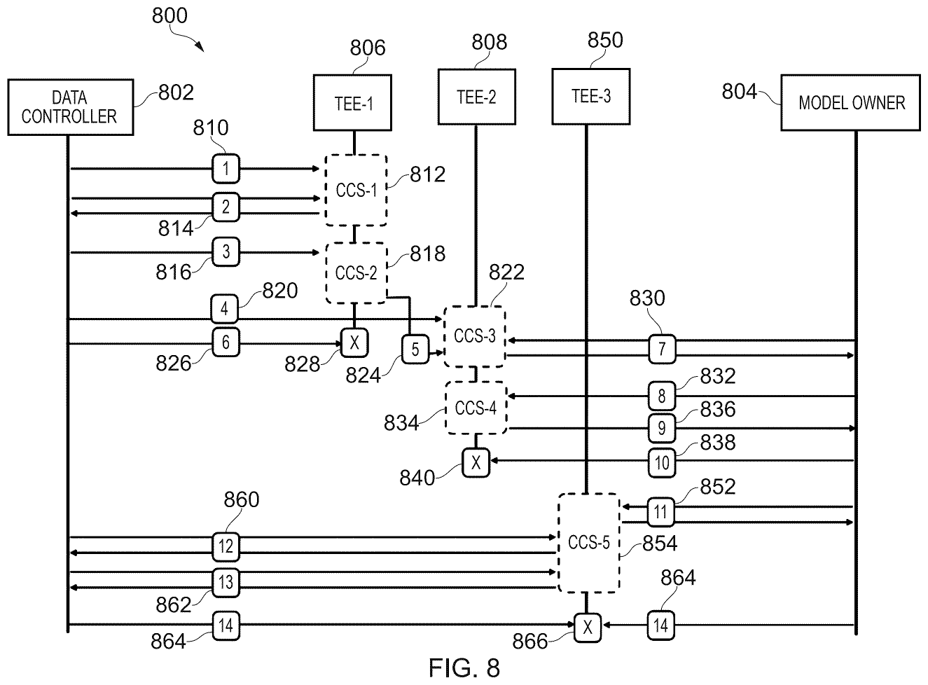

FIG. 8 shows a flow diagram 800 illustrating the steps by which a data controller 802 can collaborate confidentially with a model owner 804 using three distinct Trusted Execution Environments: a first trusted execution environment TEE-1 806; a second trusted execution environment TEE-2 808; and a third trusted execution environment TEE-3 850. Similar features in FIG. 8 to those present in FIG. 5 have been given similar reference numerals and may not necessarily be discussed further here to improve the clarity and conciseness of the disclosure. In particular, the features of the first 810, second 814 and third 816 steps (which correspond to those steps disclosed above in relation to FIG. 5) will not be discussed further here.

In a fourth step 820, the Data Controller 802 initiates a new second Trusted Execution Environment TEE-2 818 to host the synthetic data sample. It will be appreciated that TEE-2 818 may be different from TEE-1 806, for example TEE-2 808 may be instantiated on a different platform and may have different functional and security properties.

In a fifth step 824, the synthetic data generation tool having processed the sample data in CCS-2 818, a synthetic data sample with statistical properties identical (or similar) to the ones of the provided data sample are provided to TEE-2 808, thereby producing CCS-3 822.

In a sixth step 826, the Data Controller 802 securely erases 828 TEE-1 806 to prevent any potential leakage of private information.

In a seventh step 830, the model owner 804 uses a second-user second-remote-attestation protocol supported by TEE-2 808 to obtain the trustworthiness properties of the confidential computation state CCS-3 822.

In an eighth step 832, since according to the model owner policy the obtained trustworthiness properties are sufficient to trust the security of CCS-3 822, the model owner 804 provisions its tools for data analysis (machine learning models, proprietary algorithms for data analysis, etc.) to TEE-2 808, thereby creating a new confidential computation state, CCS-4 834.

In an ninth step 836, the data analysis tools process, in CCS-4 834, the synthetic data sample and output information to the model owner 804 that allows the model owner 804 to adjust the said tools for optimal performance given the specific type of data and its statistical properties.

In a tenth step 838, the model owner 804 securely erases 840 TEE-2 808 to prevent any potential leakage of private information about the data analysis model.

In an eleventh step 852, the model owner 804 initiates a new confidential computation state CCS-5 854 in the third Trusted Execution Environment TEE-3 850 and uses a second-user third-remote-attestation protocol, supported by TEE-3 850, to obtain the trustworthiness properties of the confidential computation state CCS-5 854. Having satisfied a second-user third-trust criterion, the model owner 804 deploys the tools for data analysis to TEE-3 850.

In a twelfth step 860, the Data Controller 802 uses a first-user third-remote-attestation protocol supported by TEE-3 850 to obtain the trustworthiness properties of the confidential computation state CCS-5 854.

In a thirteenth step 862, since according to the Data Controller policy the obtained trustworthiness properties are sufficient to trust the security of the CCS-5 854, the Data Controller 802 provides raw data to TEE-3 850, where the raw data is analyzed using tools provisioned by the model owner 804 to generate analysis results. Then, the analysis results are returned as an output to the Data Controller 802.

In a fourteenth step 864, once the analysis results have been obtained by the Data Controller 802, either the Data Controller 802, or the model owner 804 (or both together) securely erase 866 TEE-3 850 to prevent any potential leakage of private information about the raw data or the proprietary data analysis tools.

In the disclosure above in relation to FIG. 8, the Data Controller 802 and model owner 804 use three distinct trusted execution environments (TEE-1 806, TEE-2 808, TEE-3 850) to respectively generate synthetic data based on a private data sample (TEE-1 806), adjust the data analysis tools (TEE-2 808) and finally analyze the private data set using adjusted data analysis tools to generate the analysis results (TEE-3 850). However, the collaboration between the Data Controller 802 and the model owner 804 could also be done using a single TEE instance, as disclosed above in relation to FIG. 5. The approach of FIG. 5 may use fewer computational and hardware resources, at the potential expense of weaker security guarantees. Alternatively, the approach of FIG. 6 may use an intermediate level of computational and hardware resources, while providing for an intermediate level of security guarantees.

In the disclosures above in relation to FIGS. 4-8, the raw data set is contributed by only one data controller. However, in some examples combined data from several data controllers may be much more informative than the sum of individual data sets. To enable data set contributions from several independent data controllers, the second step and the third step of FIG. 5 can be accompanied by other steps where other data controllers also contribute their data to TEE-1, in order to create a synthetic data sample representative of the combined data set (or consecutive synthetic data samples from each separate data set owner). In such examples, each data controller contributes its respective training data set when it has established that TEE-1 is trustworthy. Each data controller can use a respective user-first-remote-attestation-protocol of a respective user-remote-attestation-procedure to determine this, by satisfaction of a respective user-first-trust-criterion of respective user-trustworthiness-criteria, as computed by TEE-1.

To illustrate the utility of multiple data controller versions of the present method, the following example is provided.

A data controller (which may be a financial institution) has a dataset containing card payment transactions. A data analysis company offers to find a solution to card payment frauds (or other types of fraudulent transactions) by analyzing the card payment transaction data with a proprietary graph processing algorithm. After making use of the approach described in relation to any of FIGS. 5 to 7 above, it may become clear that analyzing the dataset containing card payment transactions from a single institution is not enough to effectively identify and prevent fraud. Instead, combining card payment transaction data from several of the largest financial institutions can enable this. However, card payment transaction data is a highly sensitive business asset, and the financial institutions are reluctant to share it with each other.

To provide the security of confidential information necessary to enable a solution to the above scenario, a third party service can provide methods described herein as a cloud service, or use a similar external cloud service. The data controllers (e.g. major financial institutions) each contribute data to create a synthetic data set (or several synthetic data sets) based on a representative sample of time series data sets (steps 1-6 of FIG. 8 above). To do this, in steps 2-3, each data controller verifies the trustworthiness of the trusted execution environment and deploys a sample of the card payment data. Once the synthetic data set is created, the data controller sends over the synthetic data set to the data analysis company to fine-tune its graph processing algorithms (steps 7-10 of FIG. 8 above). Finally, the genuine card payment transaction data from all of the data controllers is analyzed using the fine-tuned graph processing algorithms, in a new trusted execution environment (steps 11-14 of FIG. 8 above). The obtained insights can be used to reduce fraud instances, for example (and can additionally or alternatively be provided to a fraud overviewing or law enforcement authority for appropriate action).

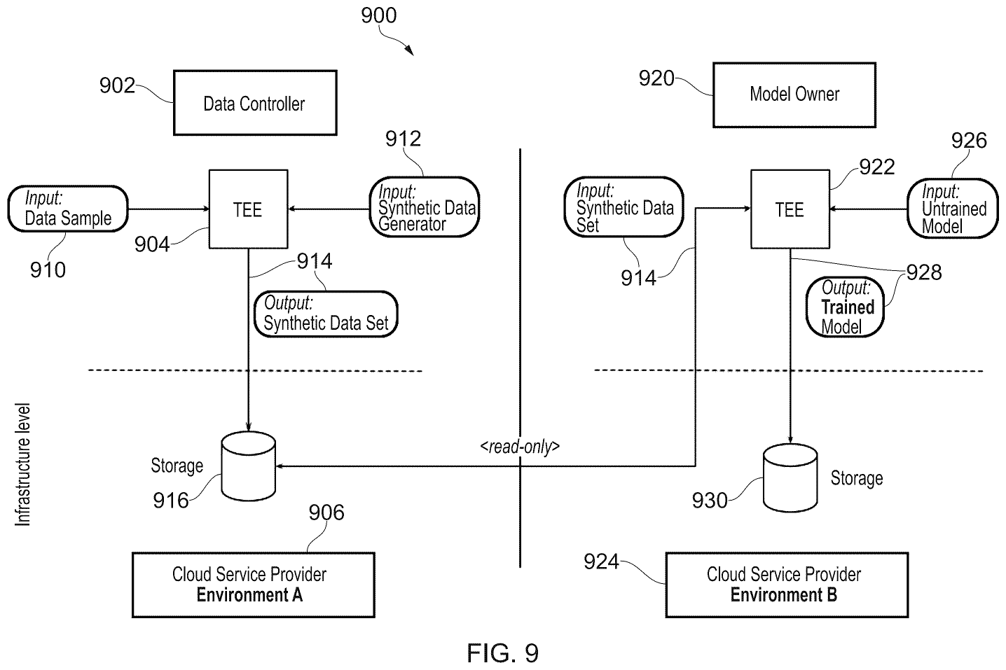

FIG. 9 shows a cloud computing system 900 for generating a trained model suitable for use in methods disclosed herein.

The present methods are suitable for use in a virtualized and distributed context and can therefore be readily implemented in a distributed manner in a cloud environment. The present methods can be implemented either by the same cloud provider or deployed across a plurality of different cloud providers, as described below. These methods can be entirely implemented in a virtualized environment.

A Data Controller 902 deploys a Trusted Execution Environment TEE-a 904 in cloud service provider Environment A 906. The TEE-a 904 receives a data sample 910 and a synthetic data generator 912 as input. The TEE-a 904 processes the data sample 910 with the synthetic data generator 912 to provide a Synthetic Data Set 914. The Synthetic Data Set 914 obtained as the execution result is then securely stored in storage solution A 916 available in the Data Controller's Environment A 906.

A Model Owner 920 deploys a Trusted Execution Environment TEE-b 922 in Environment B 924 and obtains read-only access to the Data Controller's 902 Synthetic Data Set 914 stored in storage solution A 916. The TEE-b 922 receives the Synthetic Data Set 914 and an untrained Model 926 as inputs. The TEE-b 922 generates a trained Model 928 from the Synthetic Data Set 914 and the untrained Model 926. The trained Model 928 obtained as the execution result is then securely stored in storage solution B 930 available in the Model Owner's Environment B 924.

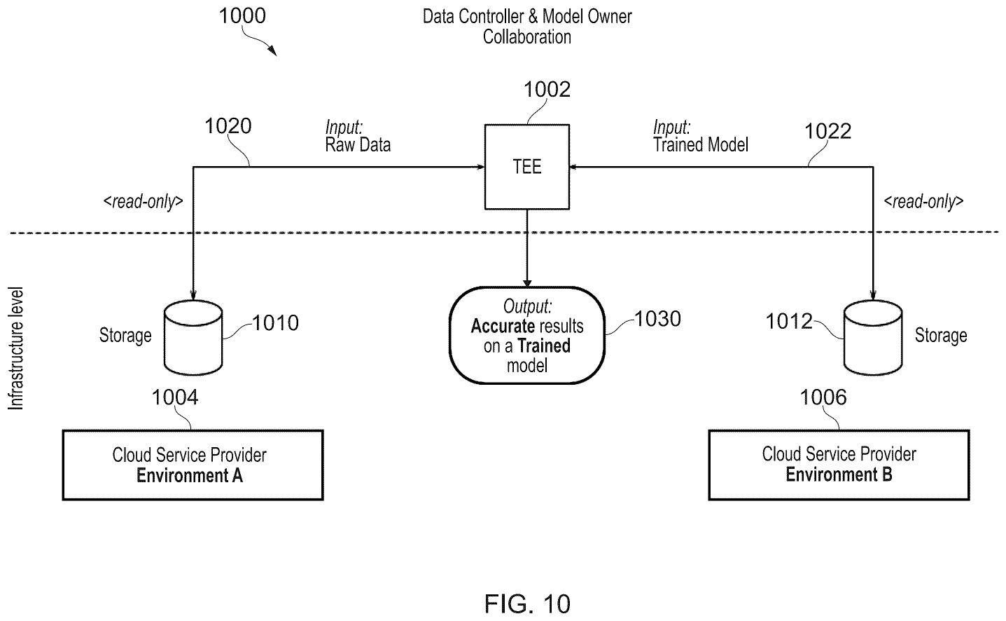

FIG. 10 shows a cloud computing system 1000 for analysing raw data using a trained model. Either a Data Controller or a Model Owner deploys a Trusted Execution Environment TEE 1002 in a cloud environment of their choice, which can be either environment A 1004 or environment B 1006, for example. The TEE 1002 has read-only access to both the Data Controller's raw data set stored at storage device A 1010 and the fine-tuned Model of the Model Owner stored at storage device B 1012.

The TEE 1002 obtains 1020 the raw data set from storage device A 1010 and also obtains 1022 the fine-tuned model from storage device B 1012. The TEE 1002 processes the raw data set using the fine-tuned Model to provide analysis results 1030.

In all the examples described above, erasure of each of the trusted execution environments (TEEs) described can be triggered automatically when the execution completes (such as by output of the analysis results), an irrecoverable failure occurs (caused for example by malformed input data), or access to the input data stream is severed (due to for example a network error or a decision by the data owner to disallow access). For example, the TEE can include embedded code that moves the TEE to another state when the execution stops due to conditions mentioned above to trigger erasure of the TEE, thereby destroying (or deleting) all the information within the TEE, including data and models.

Erasure can be done through logical techniques that render data recovery infeasible using state-of-the-art, using any of the following methods or a combination thereof:
(i) Cryptographic erase, which is a method where the media encryption key is destroyed or otherwise sanitized, making recovery of the target data infeasible (e.g. as defined by NIST:
   https://csrc.nist.gov/glossary/term/cryptographic_erase)
(ii) Block erase of memory used by the TEE;
(iii) Other methods such as Linux kernel's freed memory poisoning feature (hwpoison, as documented here:
   https://www.kernel.org/doc/html/v5.0/vm/hwpoison.html)
(iv) Powering down the RAM unit, especially in combination with the methods above or other similar methods.

Optionally, an erasure procedure would include (i) block erasure of TEE memory areas used to store the data processing function and residual data remaining in the TEE after it was processed by the data processing function; (ii) triggering instructions for overwriting freed memory, such as ‘hwpoison’ in the Linux kernel implementation which writes an arbitrary value to freed objects, so any modification or reference to that object after being freed or before being initialized will be detected and prevented. This prevents many types of use-after-free vulnerabilities at little performance cost; (iii) deletion of encryption keys used to protect the contents of the TEE and (iv) potentially triggering the power cycle of the platform running the TEE.

Typically, these logical techniques for erasure can be triggered automatically, as described above.

Examples of the present disclosure can provide the following advantageous features. The present methods provide an approach to enable secure collaboration between two or more principals for data analysis purposes even when the two or more principals do not inherently trust each other. Instead, a contextual trust relationship is established between the two or more principals (such as users of a cloud service) based the attestation results of a target TEE where the principals deploy their digital assets (data, code, software libraries, algorithms, models, etc). The trust relationship is limited to the context of the computation that is performed in the TEE based on the digital assets provided by the principals. This allows for many independent contextual trust relationships to exist between the same principles.

The present methods enable an approach to generating a synthetic data set in a trusted execution environment based on a private data set. The synthetic data set can subsequently be used by a different principal to fine-tune data analysis software (for example, train a machine learning model or adjust an algorithm). The present disclosure enables maintenance of a strong and technically verifiable level of control over digital assets and intellectual property and at the same time make them accessible to other parties.

An advantage of the invention, as described in the examples above, is that tearing down (or erasing) the TEE reliably erases all the information within the TEE, including all the data and models within the TEE. In contrast, merely erasing the information within the TEE and not erasing the TEE itself makes it potentially possible to recover data through exploiting vulnerabilities or undocumented features in the implementation of the erasing command. The invention therefore, offers a more secure and reliable destruction of both the data owned by the data owner and the data processing function owned by the data processing function owner.

Some of the other advantageous features of the present disclosure are described below.

Confidentiality of digital assets: collaborating parties can deploy digital assets provided to the TEE through a secure communication channel. Digital assets remain in the TEE and are not disclosed in plain text to either the hardware platform operator, peer collaborating parties or any other third parties, thus maintaining their confidentiality.

End-user security guarantees: end users can obtain verifiable security guarantees (attestation results) regarding the confidentiality and integrity of the environment where digital assets are processed. Through cryptographic signatures, the veracity of claims to security and integrity of data can be endorsed by the hardware platform vendor.

Performance: collaborating parties can process arbitrary data (such as text, images, sound, spatial data, etc.) using arbitrary software (such as machine learning, matrix multiplication, etc.); while the actual performance is defined by the properties of the underlying TEE. This solution allows greater versatility of digital assets and better performance compared to currently available cryptographic approaches (such as multi-party computation and fully homomorphic encryption).

Usability: the present solution can be implemented with minimal effort on the client side. Digital assets can be deployed to a TEE in similar fashion to current approaches of interacting with Internet services through a secure network connection.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1. A computer-implemented method, the method comprising:
receiving, at a data processing pipeline comprising a trusted execution environment (TEE):
a data-processing function from a data-processing function owner;
a raw-data set from a data owner;
generating, in the data processing pipeline, analysis results, based on the raw-data set, by using the data-processing function;
providing the analysis results to an output; and
erasing the trusted execution environment to erase the data-processing function, the raw-data set, and the analysis results;
wherein:
the raw-data set is provided by the data owner in response to satisfaction of first-user trustworthiness-criteria verified by the data owner using a first-user remote-attestation-procedure; and
the data-processing function is provided by the data-processing function owner in response to satisfaction of second-user trustworthiness-criteria verified by the data-processing function owner using a second-user remote attestation procedure.

2. The method of claim 1, further comprising establishing the trusted execution environment in a volatile memory device.

3. The method of claim 1, further comprising establishing the trusted execution environment according to criteria defined by at least one of the data owner and the data-processing function owner.

4. The method of claim 1, wherein erasure of the trusted execution environment results in permanent erasure of the data-processing function, the raw-data set and the analysis results from the data-processing pipeline.

5. The method of claim 1, wherein the data processing pipeline comprises a number of trusted execution environments, each trusted execution environment including a unique trusted execution environment identity.

6. The method of claim 5, wherein each trusted execution environment is erased after the analysis results associated with that trusted execution environment are provided to the output.

7. The method of claim 1, further comprising:
receiving, at the data processing pipeline a training-data set from the data owner, the training-data set suitable for training the data-processing function; and
erasing the training-data set from the data processing pipeline,
wherein the training-data set is provided by the data owner in response to satisfaction of the first-user trustworthiness-criteria determined by the trusted execution environment using the first-user remote-attestation-procedure.

8. The method of claim 7, wherein the training-data set comprises a synthetic-data sample generated by the data owner, wherein the synthetic-data sample is:
statistically representative of the raw-data set; and
distinct from the raw-data set.

9. The method of claim 7, comprising:
receiving a synthetic-data generator at the data processing pipeline;
processing, in a first-trusted-execution environment of the trusted execution environment, the training-data set, using the synthetic-data generator, to generate a synthetic-data sample, wherein:
the training-data set comprises a raw-data sample, wherein the raw-data sample is statistically representative of the raw-data set; and
the synthetic-data sample is:
statistically representative of the raw-data set;
distinct from the raw-data sample and the raw-data set; and
suitable for training the data-processing function;
wherein the training-data set is provided by the data owner in response to satisfaction of a first-user first-trust-criterion of the first-user trustworthiness-criteria determined by the first-trusted-execution environment using a first-user first-remote-attestation-protocol of the first-user remote-attestation-procedure.

10. The method of claim 9, wherein the synthetic-data sample is generated in the first-trusted-execution environment, using the synthetic-data generator, from a plurality of training-data sets, including the training-data set, each respective training-data set provided by a respective data owner in response to satisfaction of a respective user-first-trust-criterion of respective user-trustworthiness-criteria, each respective satisfaction determined by the first-trusted-execution environment using a respective user-first-remote-attestation-protocol of a respective user-remote-attestation-procedure.

11. The method of claim 9, wherein the data-processing function is an untrained-data-processing function provided by the data-processing-function owner in response to satisfaction of a second-user first-trust-criterion of the second-user trustworthiness-criteria, determined by the first-trusted-execution environment using a second-user first-remote-attestation-protocol of the second-user remote-attestation-procedure.

12. The method of claim 11, comprising:
using the first-trusted-execution environment to determine:
a trained-data-processing function based on the untrained-data-processing function and the synthetic-data sample; and
the analysis results, based on the raw-data set, by using the trained-data-processing function, wherein the raw-data set is provided by the data owner in response to satisfaction of a second first-user first-trust-criterion of the first-user trustworthiness-criteria determined by the first-trusted-execution environment using a second first-user first-remote-attestation-protocol of the first-user remote-attestation-procedure; and
erasing the trained-data-processing function and the synthetic-data sample from the data processing pipeline.

13. The method of claim 9, comprising:
providing the synthetic-data sample to the data-processing-function owner;
erasing the synthetic-data sample from the data processing pipeline;
in response to satisfaction of a second-user second-trust-criterion of the second-user trustworthiness-criteria, determined by a second-trusted-execution environment, of the trusted execution environment, using a second-user second-remote-attestation-protocol of the second-user remote-attestation-procedure, receiving at the data processing pipeline the data-processing function;
wherein the data-processing function is a trained-data-processing function, trained using the synthetic-data-sample by the data-processing-function owner;
using the second-trusted-execution environment to determine the analysis results, based on the raw-data set, by using the trained-data-processing function;
wherein the raw-data set is provided by the data owner in response to satisfaction of a first-user second-trust-criterion of the first-user trustworthiness-criteria determined by the second-trusted-execution environment using a first-user second-remote-attestation-protocol of the first-user remote-attestation-procedure.

14. The method of claim 9, comprising:
receiving the synthetic-data sample at a second-trusted-execution environment of the trusted execution environment;
in response to satisfaction of a second-user second-trust-criterion of the second-user trustworthiness-criteria, determined by the second-trusted-execution environment, using a second-user second-remote-attestation-protocol of the second-user remote-attestation-procedure, receiving at the data processing pipeline the data-processing function, wherein the data-processing function is an untrained-data-processing function;
determining a trained-data-processing function, using the second-trusted-execution environment, based on the synthetic-data sample and the untrained-data-processing function;
providing the trained-data-processing function to the data-processing-function owner; and
erasing the trained-data-processing function and the synthetic-data sample from the data processing pipeline.

15. The method of claim 14, comprising:
in response to satisfaction of a second-user third-trust-criterion of the second-user trustworthiness-criteria, determined by a third-trusted-execution environment, of the trusted execution environment, using a second-user third-remote-attestation-protocol of the second-user remote-attestation-procedure, receiving at the third-trusted-execution environment the trained-data-processing function from the data-processing-function owner;
in response to satisfaction of a first-user third-trust-criterion of the first-user trustworthiness-criteria, determined by the third-trusted-execution environment using a first-user third-remote-attestation protocol of the first-user remote-attestation-procedure, receiving at the third-trusted-execution environment the raw-data set;
determining, by the third-trusted-execution environment, the analysis results from the raw-data set and the trained-data-processing function; and
erasing the trained-data-processing function from the data processing pipeline.

16. A computer system comprising a processor and a memory, the computer system configured to execute instructions stored by the memory to:
receive, at a data processing pipeline comprising a trusted execution environment (TEE):
a data-processing function from a data-processing function owner;
a raw-data set from a data owner;
generate, in the data processing pipeline, analysis results, based on the raw-data set, by using the data-processing function;
provide the analysis results to an output; and
erase the trusted execution environment to erase the data-processing function, the raw-data set, and the analysis results;
wherein:
the raw-data set is provided by the data owner in response to satisfaction of first-user trustworthiness-criteria verified by the data owner using a first-user remote-attestation-procedure; and
the data-processing function is provided by the data-processing function owner in response to satisfaction of second-user trustworthiness-criteria verified by the data-processing function owner using a second-user remote attestation procedure.

17. The computer system according to claim 16, wherein the memory comprises a volatile memory device and the trusted execution environment is established within the volatile memory device.

18. The computer system according to claim 17, wherein the trusted execution environment is established exclusively within the volatile memory.

19. The computer system according to claim 17, wherein the volatile memory device comprises a random-access memory (RAM).

20. (canceled)

21. A computer-readable storage medium comprising instructions which, when executed by a computer system, cause the computer system to:
receive, at a data processing pipeline comprising a trusted execution environment (TEE):
a data-processing function from a data-processing function owner;
a raw-data set from a data owner;
generate, in the data processing pipeline, analysis results, based on the raw-data set, by using the data-processing function;
provide the analysis results to an output; and
erase the trusted execution environment to erase the data-processing function, the raw-data set, and the analysis results;
wherein:
the raw-data set is provided by the data owner in response to satisfaction of first-user trustworthiness-criteria verified by the data owner using a first-user remote-attestation-procedure; and
the data-processing function is provided by the data-processing function owner in response to satisfaction of second-user trustworthiness-criteria verified by the data-processing function owner using a second-user remote attestation procedure.
